(19) United States
(12) Patent Application Publication
(10) Pub. No.: US 2017/0299246 A1
(43) Pub. Date: Oct. 19, 2017

(54) ICE CHEST SYSTEM

(71) Applicant: Lancer Corporation, San Antonio, TX (US)

(72) Inventors: James G. Jensen, San Antonio, TX (US); Christopher Arocha, San Antonio, TX (US); Jack Derby, La Vernia, TX (US)

(73) Assignee: Lancer Corporation, San Antonio, TX (US)

(21) Appl. No.: 15/470,036

(22) Filed: Mar. 27, 2017

Related U.S. Application Data
(60) Provisional application No. 62/322,565, filed on Apr. 14, 2016.

(51) Int. Cl. F25D 3/06; F16M 11/16; F25D 31/00; B67D 1/08

(52) U.S. Cl. CPC F25D 3/06; B67D 1/0857; F16M 11/16; F25D 31/002; F16M 2200/025; F25D 2400/12

(57) ABSTRACT

An ice chest system includes an ice chest and first, second, third, and fourth legs removably securable with the ice chest. The ice chest includes a top, a bottom, and first, second, third, and fourth sides defining an ice bin. First and second pins are mechanically connected with the first, second, third, and fourth sides at each end thereof. The first, second, third, and fourth legs each include a first surface having first and second engagement slots and a second surface having first and second engagement slots. Securing the first, second, third, and fourth legs with the ice chest includes engaging the first and second engagement slots of the first, second, third, and fourth legs with the first and second pins of the first, second, third, and fourth sides.

### CROSS-REFERENCE TO RELATED APPLICATION

This present application claims all available benefit, under 35 U.S.C. §119(e), of U.S. provisional patent application Ser. No. 62/322,565 filed Apr. 14, 2016. By this reference, the full disclosure of U.S. provisional patent application Ser. No. 62/322,565 is incorporated herein as though now set forth in its entirety

### BACKGROUND OF THE INVENTION

### 1. Field of the Invention

The present invention relates to ice storage and, more particularly, but not by way of limitation, to an ice chest system.

### 2. Description of the Related Art

Beverage dispensers are well known in the art and are used extensively in restaurants, bars, concession stands, movie theaters, gas stations, and the like. Beverage dispensers are often used in conjunction with ice chests such as a cold plate ice chest. Cold plate ice chests are used to re ice for inclusion in individual beverages as well as to chill flavoring syrups and diluents, such as carbonated and plain water, prior to their mixing and dispensing into a finished drink by a beverage dispenser. FIG. 1 illustrates a cold plate ice chest 500 and frame 502 well known in the art. The cold plate ice chest 500 includes an ice storage container 501 with an integrated cold plate heat exchanger (not shown) attached to the bottom surface of the ice storage container 501. Furthermore, a frame 502 supports the vertical load of the ice storage container 501, cold plate heat exchanger, and any ice stored within the ice storage container 501.

The frame 502 includes legs 503 that are attached thereto using welds, which must be ground down and polished after the attachment of the legs 503. Once assembled, the frame 502 creates an aesthetically pleasing look while providing a structure that supports the vertical load described above. However, assembling the frame 502 using welds increases production time and therefore manufacturing costs. In addition, shipping costs are increased in that separate containers are required to ship the cold plate ice chest 500 and the frame 502; one container for the cold plate ice chest 500 and one container for the frame 502, which is mostly empty due to the shape of the frame 502. Furthermore, the legs 503 attach at their tops to the underside of the frame 502 using a thin weld. Unfortunately, thin welds produce only a limited thermal connection due to the small surface area used to attach the legs 503 to the underside of the frame 502. This design satisfactorily supports vertical loads, however, the assembly of the frame 502 using welds makes the frame 502 susceptible to collapse from lateral loads.

Accordingly, a cold plate ice chest support system that lowers manufacturing and shipping costs as well as handles increased lateral loads would be beneficial.

### SUMMARY OF THE INVENTION

In accordance with the present invention, an ice chest system includes an ice chest and first, second, third, and fourth legs removably connected with the ice chest. The ice chest, which may be a cold plate ice chest, includes a top, a bottom, and first, second, third, and fourth sides defining an ice bin. The top includes a lid that seals the ice chest while allowing access thereto when the ice chest is filled with ice. The first, second, third, and fourth sides at each end thereof include first and second pins mechanically connected therewith.

The first leg includes a first surface having first and second engagement slots and a second surface including first and second engagement slots. The first leg includes a third surface formed integrally with the first surface and a fourth surface formed integrally with the second surface that reside in a substantially horizontal plane to form a bottom portion of the first The first leg aligns with the ice chest at a corner of the ice chest defined by the first and second sides such that the first surface resides adjacent the first side and the second surface resides adjacent the second side. The first and second engagement slots of the first surface engage respective first and second pins mechanically connected with the first side and the first and second engagement slots of the second surface engage respective first and second pins mechanically connected with the second side such that the first surface abuts the first side and the second surface abuts the second side. The first and second engagement slots each include a receiving slot that receives one of the first and second pins therethrough and a locking slot that locks one of the first and second pins in the engagement slot.

The second leg includes a first surface having first and second engagement slots and a second surface including first and second engagement slots. The second leg includes a third surface formed integrally with the first surface and a fourth surface formed integrally with the second surface that reside in a substantially horizontal plane to form a bottom portion of the second leg. The second leg aligns with the ice chest at a corner of the ice chest defined by the second and third sides such that the first surface resides adjacent the second side and the second surface resides adjacent the third side. The first and second engagement slots of the first surface engage respective first and second pins mechanically connected with the second side and the first and second engagement slots of the second surface engage respective first and second pins mechanically connected with the third side such that the first surface abuts the second side and the second surface abuts the third side. The first and second engagement slots each include a receiving slot that receives one of the first and second pins therethrough and a locking slot that locks one of the first and second pins in the engagement slot.

The third leg includes a first surface having first and second engagement slots and a second surface including first and second engagement slots. The third leg includes a third surface formed integrally with the first surface and a fourth surface formed integrally with the second surface that reside in a substantially horizontal plane to form a bottom portion of the third leg. The third leg aligns with the ice chest at a corner of the ice chest defined by the third and fourth sides such that the first surface resides adjacent the third side and the second surface resides adjacent the fourth side. The first and second engagement slots of the first surface engage respective first and second pins mechanically connected with the third side and the first and second engagement slots of the second surface engage respective first and second pins mechanically connected with the fourth side such that the first surface abuts the third side and the second surface abuts the fourth side. The first and second engagement slots each include a receiving slot that receives one of the first and second pins therethrough and a locking slot that locks one of the first and second pins in the engagement slot.

The fourth leg includes a first surface having first and second engagement slots and a second surface including first and second engagement slots. The fourth leg includes a third surface formed integrally with the first surface and a fourth surface formed integrally with the second surface that reside in a substantially horizontal plane to form a bottom portion of the fourth leg. The fourth leg aligns with the ice chest at a corner of the ice chest defined by the fourth and first sides such that the first surface resides adjacent the fourth side and the second surface resides adjacent the first side. The first and second engagement slots of the first surface engage respective first and second pins mechanically connected with the fourth side and the first and second engagement slots of the second surface engage respective first and second pins mechanically connected with the first side such that the first surface abuts the fourth side and the second surface abuts the first side. The first and second engagement slots each include a receiving slot that receives one of the first and second pins therethrough and a locking slot that locks one of the first and second pins in the engagement slot.

In a method for an ice chest system, the ice chest and the first, second, third, and fourth legs disconnected from the ice chest are inserted into a shipping container, and the shipping container is delivered to an end user. The ice chest and the first, second, third, and fourth legs are removed from the shipping container and assembled by coupling the first, second, third, and fourth legs with the ice chest at the corners thereof using the first and second engagement slots and the first and second pins.

### BRIEF DESCRIPTION OF DRAWINGS

FIG. 1 illustrates a prior art cold plate ice chest and frame.

FIGS. 2 and 3 are perspective views illustrating an ice chest system according to a preferred embodiment.

FIGS. 4 and 5 are a perspective views illustrating a leg of the ice chest system according to a preferred embodiment.

FIG. 6 is a bottom view illustrating the leg of the ice chest system according to a preferred embodiment.

FIG. 7 is perspective views illustrating an ice chest system according to a preferred embodiment.

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. Figures are not necessarily to scale, and some features may be exaggerated to show details of particular components or steps.

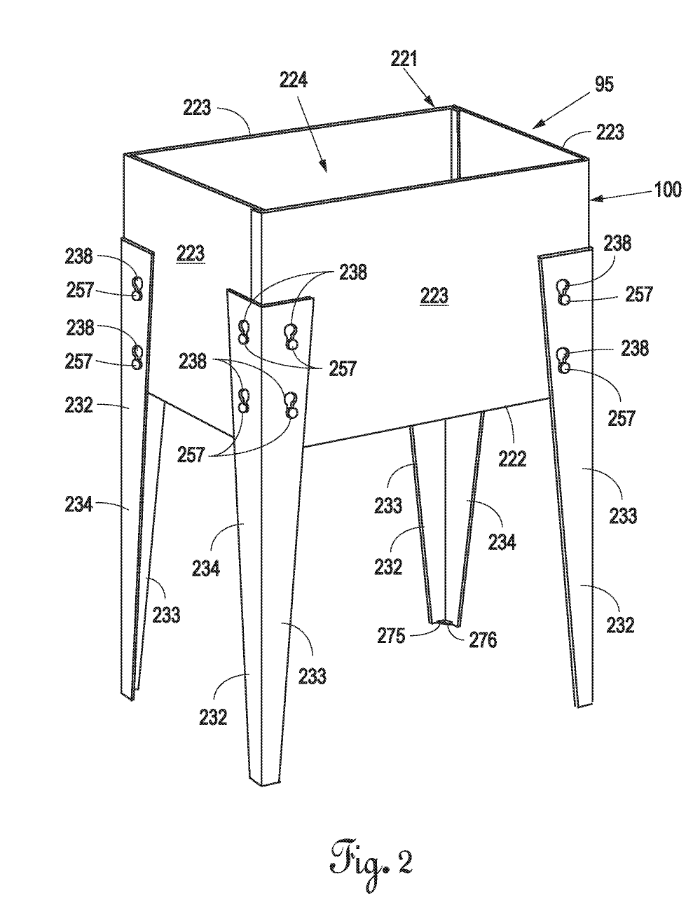

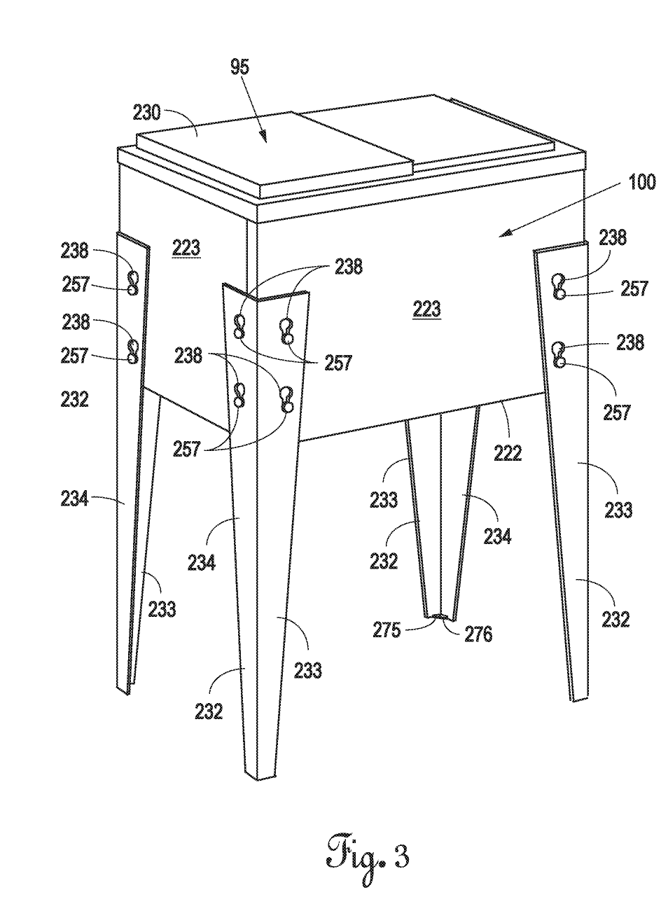

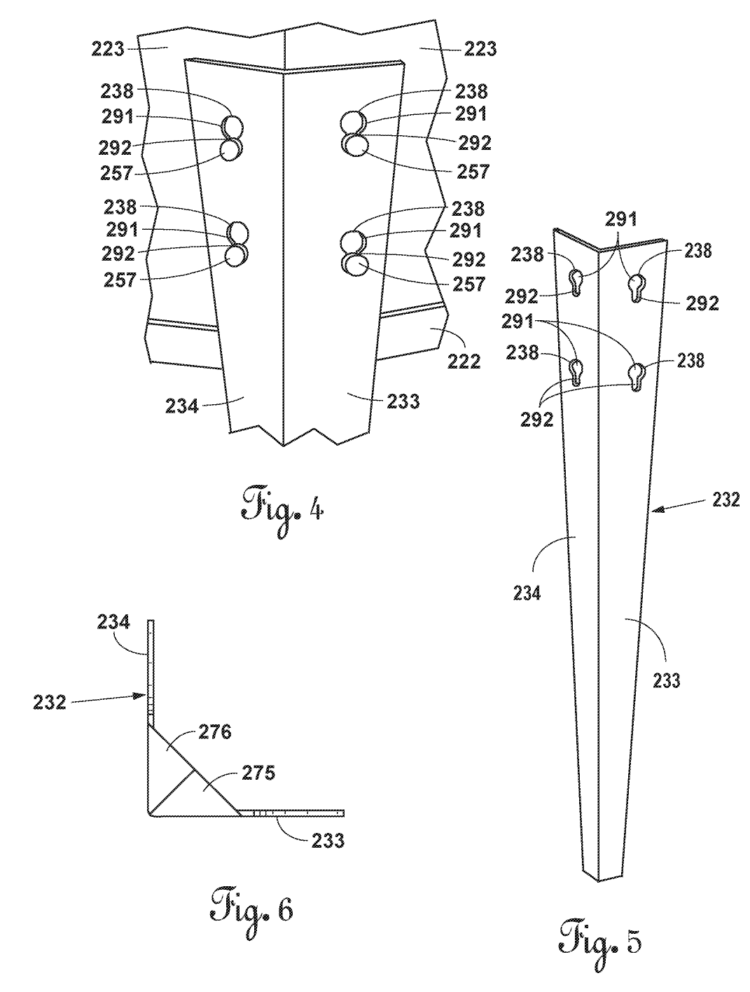

FIGS. 2-6 illustrate an ice chest system 95 that includes legs 232 that support an ice chest. While the ice chest system 95 may include any chest suitable for holding ice, the ice chest in the preferred embodiment is a cold plate ice chest 100. The legs 232 and the cold plate ice chest 100 can be made of any suitable material, however, in the preferred embodiment, the cold plate ice chest 100 and the legs 232 are stainless steel.

The cold plate ice chest 100 is designed to store ice for customers and/or to cool beverages dispensed from a beverage dispenser. The cold plate ice chest 100 includes a top 221, a bottom 222, sides 223 defining an ice bin 224, and a cold plate heat exchanger (not shown) disposed in the bottom 222 of the ice bin 224 or forming the bottom 222 thereof.

The ends of each of the sides 223 include two pins 257 for a total of sixteen pins 257. The pins 257 attach to the sides 223 using any suitable means such as rivets (e.g., headed shoulder hollow rivets) that provide a mechanical connection rather than a thermal connection. The top 221 includes a lid 230 that seals the cold plate ice chest 100 while allowing access thereto when the cold plate ice chest 100 is filled with ice. In addition, to furnishing ice for dispensed beverages, ice stored within the cold plate ice chest 100 cools the cold plate heat exchanger (not shown). lines carrying flavored syrup and diluent, such as carbonated and plain water, run through the cold plate heat exchanger and to the beverage dispenser. The cold plate heat exchanger accordingly cools the flavored syrup and diluent prior to mixing and pouring into a customer's drink.

The legs 232 include a first surface 233, a second surface 234, a third surface 275, and a fourth surface 276. The third and fourth surfaces 275 and 276 in the preferred embodiment, respectively, are formed integrally with the first and second surfaces 234 and 235 and reside in a substantially horizontal plane to form a bottom portion of the legs 232. Furthermore, the first surface 233 and the second surface 234 include engagement slots 238 that engage the pins 257 of the sides 223. The engagement slots 238 each include a receiving slot 291 and a locking slot 292.

The ice chest system 95 assembles in the following manner. The cold plate ice chest 100 is placed on its top 221, and one of the legs 232 is selected for attachment to the cold plate ice chest 100. The selected leg 232 aligns with the cold plate ice chest 100 at a corner thereof such that the first surface 233 and the second surface 234 reside adjacent the sides 223. Once the selected leg 232 is aligned, pins 257 on the sides near the corner insert through the receiving slots 291 of the first surface 233 and the second surface 234 thereby allowing the first surface 233 and the second surface 234 to abut the sides 223. After the pins 257 pass through the receiving slots 291, the selected leg 232 is ready for locking with the cold plate ice chest 100. To lock the leg 232 with the cold plate ice chest 100, the first surface 233 and the second surface 234 of the leg 232 is maneuvered such that the pins 257 move from the receiving slots 291 into the locking slots 292, thereby engaging the locking slots 292 and locking the first surface 233 and the second surface 234 to the cold plate ice chest 100. Upon locking the first surface 233 and the second surface 234 with the cold plate ice chest 100, the leg 232 will be substantially completely locked to the cold plate ice chest 100. This process of locking the legs 232 to the cold plate ice chest 100 is repeated with the remaining legs 232 until four legs 232 have been locked to the sides 223 of the cold plate ice chest 100 thereby completing assembly of the ice chest system 95.

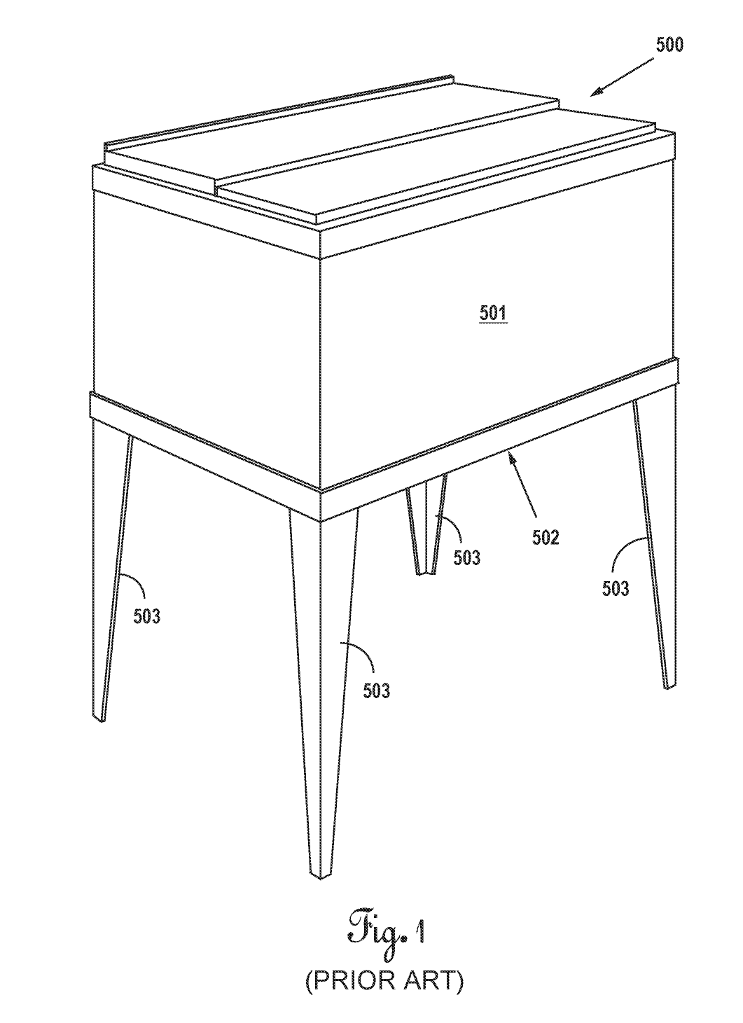

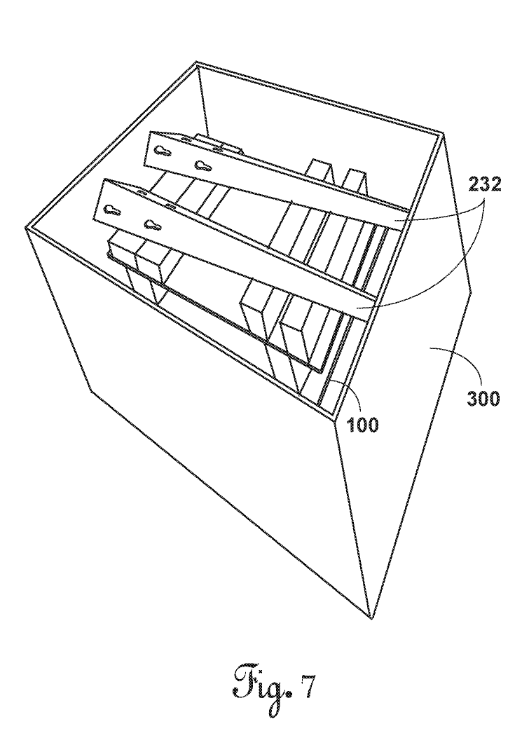

The ice chest system 95 illustrated in FIGS. 3-10 improves upon the frame 502 illustrated in FIGS. 1 and 2 by lowering manufacturing costs, decreasing shipping costs, and increasing the amount of lateral load that the ice chest system 95 can withstand. As described above, the legs 232 secure with cold plate ice chest 100 using the engagement slots 291 in combination with the pins 257 as opposed to the welding, grinding, and polishing used to secure the legs 503 with the frame 502. Eliminating welding, grinding, polishing saves time by removing a labor-intensive manufacturing process thereby lowering manufacturing costs. Furthermore, securing the legs 232 to the cold plate ice chest 100 using engagement slots 291 in combination with the pins 257 allows the ice chest system 95 to be assembled and disassembled on site with no tools, which simplifies assembly and permits shipping of the cold plate ice chest 100 and the legs 232 in the same container 300 as illustrated in FIG. 7, thereby reducing shipping costs. Finally, the design of the ice chest system 95 allows the ice chest system 95 to withstand increased vertical and lateral loads compared to the frame 502. Specifically, the design of the legs 232 such that the first surface 233 and the second surface 234 abut the sides 223 of the cold plate ice chest 100 increases the area of surface contact between the cold plate ice chest 100 and the legs 232 over that of the welds used in the frame 502. This greater surface area creates a stronger structure that can withstand increased vertical and lateral loads because, once the ice chest system 95 is assembled, a vertical or lateral force applied to the ice chest system 95 is distributed through the greater surface area presented by the first surface 233 and the second surface 234 of the legs 232 as opposed to the thin welds of the frame 502.

Although the present invention has been described in terms of the foregoing preferred embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

1. An ice chest system, comprising:
an ice chest, comprising a top, a bottom, and first, second, third, and fourth sides defining an ice bin;
at least one pin mechanically connected with the first, second, third, and fourth sides at each end thereof;
a first leg, comprising a first surface including at least one engagement slot and a second surface including at least one engagement slot, wherein:
the first leg aligns with the ice chest at a corner of the ice chest defined by the first and second sides such that the first surface resides adjacent the first side and the second surface resides adjacent the second side, and
the engagement slot of the first surface engages the pin mechanically connected with the first side and the engagement slot of the second surface engages the pin mechanically connected with the second side such that the first surface abuts the first side and the second surface abuts the second side;
a second leg, comprising a first surface including at least one engagement slot and a second surface including at least one engagement slot, wherein:
the second leg aligns with the ice chest at a corner of the ice chest defined by the second and third sides such that the first surface resides adjacent the second side and the second surface resides adjacent the third side, and
the engagement slot of the first surface engages the pin mechanically connected with the second side and the engagement slot of the second surface engages the pin mechanically connected with the third side such that the first surface abuts the second side and the second surface abuts the third side;
a third leg, comprising a first surface including at least one engagement slot and a second surface including at least one engagement slot, wherein:
the third leg aligns with the ice chest at a corner of the ice chest defined by the third and fourth sides such that the first surface resides adjacent the third side and the second surface resides adjacent the fourth side, and
the engagement slot of the first surface engages the pin mechanically connected with the third side and the engagement slot of the second surface engages the pin mechanically connected with the fourth side such that the first surface abuts the third side and the second surface abuts the fourth side; and
a fourth leg, comprising a first surface including at least one engagement slot and a second surface including at least one engagement slot, wherein:
the fourth leg aligns with the ice chest at a corner of the ice chest defined by the fourth and first sides such that the first surface resides adjacent the fourth side and the second surface resides adjacent the first side, and
the engagement slot of the first surface engages the pin mechanically connected with the fourth side and the engagement slot of the second surface engages the pin mechanically connected with the first side such that the first surface abuts the fourth side and the second surface abuts the first side.

2. The ice chest system according to claim 1, wherein the ice chest is a cold plate ice chest.

3. The ice chest system according to claim 1, wherein the top includes a lid that seals the ice chest while allowing access thereto when the ice chest is filled with ice.

4. The ice chest system according to claim 1, wherein the first, second, third, and fourth legs each include a third surface formed integrally with the first surface and a fourth surface formed integrally with the second surface, wherein the third and fourth surfaces reside in a substantially horizontal plane to form a bottom portion of the first, second, third, and fourth legs.

5. The ice chest system according to claim 1, wherein each engagement slot includes a receiving slot that receives the at least one pin therethrough and a locking slot that locks the at least one pin in the engagement slot.

6. An ice chest system, comprising:
an ice chest, comprising a top, a bottom, and first, second, third, and fourth sides defining an ice bin;
first and second pins mechanically connected with the first, second, third, and fourth sides at each end thereof;
a first leg, comprising a first surface including first and second engagement slots and a second surface including first and second engagement slots, wherein:
the first leg aligns with the ice chest at a corner of the ice chest defined by the first and second sides such that the first surface resides adjacent the first side and the second surface resides adjacent the second side, and
the first and second engagement slots of the first surface engage respective first and second pins mechanically connected with the first side and the first and second engagement slots of the second surface engage respective first and second pins mechanically connected with the second side such that the first surface abuts the first side and the second surface abuts the second side;
a second leg, comprising a first surface including first and second engagement slots and a second surface including first and second engagement slots, wherein:
the second leg aligns with the ice chest at a corner of the ice chest defined by the second and third sides such that the first surface resides adjacent the second side and the second surface resides adjacent the third side, and
the first and second engagement slots of the first surface engage respective first and second pins mechanically connected with the second side and the first and second engagement slots of the second surface engage respective first and second pins mechanically connected with the third side such that the first surface abuts the second side and the second surface abuts the third side;
a third leg, comprising a first surface including first and second engagement slots and a second surface including first and second engagement slots, wherein:
the third leg aligns with the ice chest at a corner of the ice chest defined by the third and fourth sides such that the first surface resides adjacent the third side and the second surface resides adjacent the fourth side, and
the first and second engagement slots of the first surface engage respective first and second pins mechanically connected with the third side and the first and second engagement slots of the second surface engage respective first and second pins mechanically connected with the fourth side such that the first surface abuts the third side and the second surface abuts the fourth side; and
a fourth leg, comprising a first surface including first and second engagement slots and a second surface including first and second engagement slots, wherein:
the fourth leg aligns with the ice chest at a corner of the ice chest defined by the fourth and first sides such that the first surface resides adjacent the fourth side and the second surface resides adjacent the first side, and
the first and second engagement slots of the first surface engage respective first and second pin mechanically connected with the fourth side and the first and second engagement slots of the second surface engage respective first and second pins mechanically connected with the first side such that the first surface abuts the fourth side and the second surface abuts the first side.

7. The ice chest system according to claim 6, wherein the ice chest is a cold plate ice chest.

8. The ice chest system according to claim 6, wherein the top includes a lid that seals the ice chest while allowing access thereto when the ice chest is filled with ice.

9. The ice chest system according to claim 6, wherein the first, second, third, and fourth legs each include a third surface formed integrally with the first surface and a fourth surface formed integrally with the second surface, wherein the third and fourth surfaces reside in a substantially horizontal plane to form a bottom portion of the first, second, third, and fourth legs.

10. The ice chest system according to claim 6, wherein the first and second engagement slots each include a receiving slot that receives one of the first and second pins therethrough and a locking slot that locks one of the first and second pins in the engagement slot.

11. A method for an ice chest system, comprising:
providing an ice chest, comprising a top, a bottom, and first, second, third, and fourth sides defining an ice bin;
mechanically connecting a first pin with the first, second, third, and fourth sides at each end thereof;
providing first, second, third, and fourth legs, wherein the first, second, third, and fourth legs each comprise a first surface including a first engagement slot and a second surface including first engagement slot;
inserting the ice chest and the first, second, third, and fourth legs disconnected from the ice chest into a shipping container;
delivering the shipping container to an end user;
removing the ice chest and the first, second, third, and fourth legs from the shipping container;
coupling the first leg with the ice chest, comprising:
aligning the first leg with the ice chest at a corner of the ice chest defined by the first and second sides such that the first surface resides adjacent the first side and the second surface resides adjacent the second side, and
engaging the first engagement slot of the first surface with the first pin mechanically connected with the first side and the first engagement slot of the second surface with the first pin mechanically connected with the second side such that the first surface abuts the first side and the second surface abuts the second side;
coupling the second leg with the ice chest, comprising:
aligning the second leg with the ice chest at a corner of the ice chest defined by the second and third sides such that the first surface resides adjacent the second side and the second surface resides adjacent the third side, and
engaging the first engagement slot of the first surface with the first pin mechanically connected with the second side and the first engagement slot of the second surface with the first pin mechanically connected with the third side such that the first surface abuts the second side and the second surface abuts the third side;
coupling the third leg with the ice chest, comprising:
aligning the third leg with the ice chest at a corner of the ice chest defined by the third and fourth sides such that the first surface resides adjacent the third side and the second surface resides adjacent the fourth side, and
engaging the first engagement slot of the first surface with the first pin mechanically connected with the third side and the first engagement slot of the second surface with the first pin mechanically connected with the fourth side such that the first surface abuts the third side and the second surface abuts the fourth side; and
coupling the fourth leg with the ice chest, comprising:
aligning the fourth leg with the ice chest at a corner of the ice chest defined by the fourth and first sides such that the first surface resides adjacent the fourth side and the second surface resides adjacent the first side, and
engaging the first engagement slot of the first surface with the first pin mechanically connected with the fourth side and the first engagement slot of the second surface with the first pin mechanically connected with the first side such that the first surface abuts the fourth side and the second surface abuts the first side.

12. The method for an ice chest system according to claim 11, further comprising:
mechanically connecting a second pin with the first, second, third, and fourth sides at each end thereof;
providing the first and second surfaces for each of the first, second, third, and fourth legs with a second engagement slot; and
coupling the first, second, third, and fourth legs with the ice chest comprises engaging the second engagement slots of the first, second, third, and fourth legs with the second pins of the first, second, third, and fourth sides.

13. The method for an ice chest system according to claim 11, wherein the ice chest is a cold plate ice chest.

14. The method for an ice chest system according to claim 11, wherein the top includes a lid that seals the ice chest while allowing access thereto when the ice chest is filled with ice.

15. The method for an ice chest system according to claim 11, wherein the first, second, third, and fourth legs each include a third surface formed integrally with the first surface and a fourth surface formed integrally with the second surface, wherein the third and fourth surfaces reside in a substantially horizontal plane to form a bottom portion of the first, second, third, and fourth legs.

16. The method for an ice chest system according to claim 12, wherein the first and second engagement slots each include a receiving slot that receives one of the first and second pins therethrough and a locking slot that locks one of the first and second pins in the engagement slot.
